(19) United States
(12) Patent Application Publication
(10) Pub. No.: US 2018/0286395 A1
(43) Pub. Date: Oct. 4, 2018

(54) SPEECH RECOGNITION DEVICES AND SPEECH RECOGNITION METHODS

(71) Applicant: Lenovo (Beijing) Co., Ltd., Beijing (CN)

(72) Inventors: Xiaolong LI, Beijing (CN); Rui WANG, Beijing (CN); Yan MA, Beijing (CN)

(21) Appl. No.: 15/819,401

(22) Filed: Nov. 21, 2017

(30) Foreign Application Priority Data
Mar. 28, 2017 (CN) 201710195971.X

(51) Int. Cl. G10L 15/22; G10L 17/04; G10L 17/06; G10L 17/00

(52) U.S. Cl. CPC G10L 15/22; G10L 17/04; G10L 17/06; G06F 17/214; G10L 2015/223; G10L 2015/227; G10L 17/005

(57) ABSTRACT

The present disclosure provides a speech recognition method and a speech recognition device. The speech recognition method includes receiving a voice instruction of a user. In response to the received voice instruction of the user, the speech recognition method further includes obtaining affixed information related to the user and providing a personalized service based on the received voice instruction of the user and the affixed information related to the user. The affixed information may include at least one of the user's location, the user's age, the user's gender, and the user's identity.

### CROSS-REFERENCES TO RELATED APPLICATIONS

This application claims priority of Chinese Patent Application No. 201710195971.X filed on Mar. 28, 2017, the entire contents of which are hereby incorporated by reference.

### FIELD OF THE DISCLOSURE

The present disclosure generally relates to the field of electronic technologies and, more particularly, relates to speech recognition devices and speech recognition methods.

### BACKGROUND

With the development of computer technology, artificial intelligence (AI) systems have been more and more widely used. AI systems used for man-machine conversation have been extensively applied to various fields including smart home, online education, network office, etc. Usually, conventional man-machine conversation systems can only be used to provide services based on the requests of the users, but cannot be used to provide personalized services for different users.

Therefore, intelligent interactive systems and intelligent interactive methods that meet the requirements for providing personalized service based on the difference of the users are needed. The disclosed speech recognition methods and devices are directed to solve one or more problems set forth above and other problems in the art.

### BRIEF SUMMARY OF THE DISCLOSURE

One aspect of the present disclosure provides a speech recognition method. The speech recognition method includes receiving a voice instruction of a user. In response to the received voice instruction of the user, the speech recognition method further includes obtaining affixed information related to the user and then providing a personalized service based on the received voice instruction of the user and the affixed information.

Another aspect of the present disclosure provides a speech recognition device. The speech recognition device includes a centralized controller, coupled with a storage device for pre-storing a plurality of service options corresponding to voice instructions and affixed information of users. In response to a voice instruction provided from at least one audio device, the centralized controller provides one of a service and service options based on the voice instruction and the affixed information of a user to the at least one audio device to provide a personalized service.

Another aspect of the present disclosure provides a speech recognition device. The speech recognition device includes at least one audio device, each comprising a sound collector for receiving a voice instruction of a user and a processor. In response to a voice instruction of a user received through the sound collector, the processor determines affixed information of the user, receives, from a centralized controller, one or more of a service and service options based on the voice instruction and the affixed information of the user, and provides a personalized service.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a block diagram of a speech recognition device consistent with some embodiments of the present disclosure;

FIGS. 2(a)-2(c) illustrate schematic diagrams of operation examples to provide a personalized service based on the received voice instruction of the user and the affixed user information consistent with some embodiments of the present disclosure;

FIG. 3 illustrates a schematic diagram of an application scenario of a speech recognition device consistent with some embodiments of the present disclosure;

FIG. 4 illustrates a schematic diagram of another application scenario of a speech recognition device consistent with some embodiments of the present disclosure; and

FIG. 5 illustrates a schematic flowchart of a speech recognition method consistent with some embodiments of the present disclosure.

### DETAILED DESCRIPTION

Reference will now be made in detail to various embodiments of the disclosure, which are illustrated in the accompanying drawings. Wherever possible, the same reference numbers will be used throughout the drawings to refer to the same or like parts. The described embodiments are some but not all of the embodiments of the present disclosure. Based on the disclosed embodiments and without inventive efforts, persons of ordinary skill in the art may derive other embodiments consistent with the present disclosure, all of which are within the scope of the present disclosure.

The disclosed embodiments in the present disclosure are merely examples for illustrating the general principles of the disclosure. Any equivalent or modification thereof, without departing from the spirit and principle of the present disclosure, falls within the true scope of the present disclosure.

Moreover, in the present disclosure, the term “and/or” may be used to indicate that two associated objects may have three types of relations. For example, “A and/or B” may represent three situations: A exclusively exists, A and B coexist, and B exclusively exists. In addition, the character “/” may be used to indicate an “exclusive” relation between two associated objects.

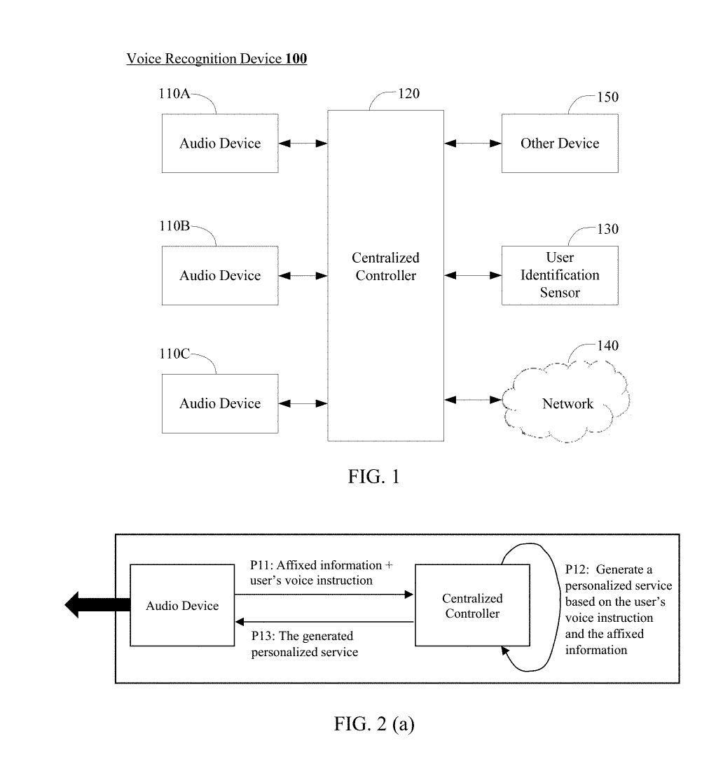

The present disclosure provides a speech recognition method and a speech recognition device that can provide personalized service for different users based on the voice instruction of the user and the affixed information related to the speaker (i.e., the user). FIG. 1 shows a block diagram of a speech recognition device consistent with some embodiments of the present disclosure.

Referring to FIG. 1, the speech recognition device 100 may include one or more audio devices. For example, in one embodiment, the speech recognition device 100 includes three audio devices, i.e., 110A, 110B, and 110C. Each audio device may include a sound collector such that the audio devices may be able to receive voice instructions of users. The speech recognition device 100 may also include a centralized controller 120 communicating with the audio devices. The communication between the centralized controller and each audio device may be through a wired method or a wireless method. Optionally, the one or more audio devices may also be able to play sound or broadcast such that audio feedback may be provided to the user. In response to a received voice instruction of a user, the centralized controller 120 may obtain and send out affixed information related to the user, and then provide a personalized service based on the received voice instruction of the user and the affixed information related to the user. In one embodiment, the centralized controller includes a hardware processor, a CPU, etc. In various embodiments, the centralized controller may refer to centralized controller hardware. The centralized controller may be located locally or remotely with respect to the audio devices. For example, the centralized controller may be a cloud centralized controller including a cloud storage device.

The voice instruction of the user may be an input sound file. The voice instruction of the user may be translated to a text content based on a unique voiceprint of the user. The text content extracted from the voice instruction of the user may then be used to instruct the centralized controller 120 to provide a personalized service based on the affixed information related to the user. The voiceprint of the user may include the frequency of the user's voice, the accent of the user, etc. The affixed information related to the user may include the identity of the user, the environmental parameters, etc.

The speech recognition device may pre-store voiceprints of different users. Therefore, by comparing the received voice instruction of the user to the pre-stored voiceprints of different users, the centralized controller of the speech recognition device may be able to determine the identity of the user. Moreover, the environmental parameters of the voice instruction may include the time information, the location information (e.g. the location parameter in a global positioning system), etc. The environmental parameters of the voice instruction may be obtained through a plurality of sensors connected to the speech recognition device or integrated into the speech recognition device.

In one embodiment, the affixed information may include at least one of the user's location, the user's category, etc. For example, the user's category may have various definitions according to different attributes (e.g., age, gender, identity, etc.) of the users. Therefore, the affixed information may include at least one of the user's location, the user's age, the user's gender, the user's identity, etc. The user's category may be obtained through the analysis of the voiceprint of the user or through one or more sensors. Therefore, providing personalized services may include providing services at different permission levels in response to different user's locations and/or different user's categories. The different permission levels may refer to different service types. For example, a first permission level may be called a first service type, and a second permission level may be called a second service type. Alternatively, providing personalized services may also include using different methods to provide a same service in response to different user's locations and/or different user's categories. In the following, examples will be provided to illustrate various methods for providing personalized service.

In one embodiment, the centralized controller 120 may be a single controller, or may include two or more devices with a control function. For example, the centralized controller 120 may include a general-purpose controller, an instruction processor and/or associated chipset, and/or a customized micro-controller (e.g., an application specific integrated circuit, etc.). The centralized controller 120 may be a portion of a single integrated circuit (IC) chip or a single device (e.g. a personal computer, etc.).

The centralized controller 120 may also be connected to other devices 150 including television, refrigerator, etc. so that by controlling the other devices using a voice instruction obtained from the audio devices, a service corresponding the voice instruction may then be provided. In addition, the centralized controller 120 may be connected to a network 140, and thus, the corresponding service may be provided through the network 140 based on the request of the user. Moreover, the centralized controller 120 may be connected to an external cloud storage device such that feedback information corresponding to the request of the user may be provided through cloud service. The centralized controller 120 may also include an internal cloud storage device to realize fast response, personal information backup, security control, and other functions. For example, the information related to personal privacy may be backed up to a private cloud storage device, i.e. an internal cloud storage device of the centralized controller 120, in order to protect personal privacy. Moreover, the external cloud storage device and/or the internal cloud storage device may store a plurality of voiceprints of different users, a plurality of service options at different permission levels, a plurality of presenting methods, etc. in order to provide a personalized service in response to a voice instruction of a user.

In one embodiment, the centralized controller 120 may be connected to a user identification sensor 130 (e.g. a camera, a smart floor, etc.) to obtain affixed information related to the user. For example, a user's picture taken by a camera may be used to obtain the identity of the user and/or the location of the user. In addition, the centralized controller 120 may also directly collect the affixed information related to the user through audio devices that are connected to the centralized controller 120. For example, the identity of the user may be determined by analyzing the voiceprint of the voice collected by the audio devices, or the location of the user may be determined using the positioning function of the audio devices.

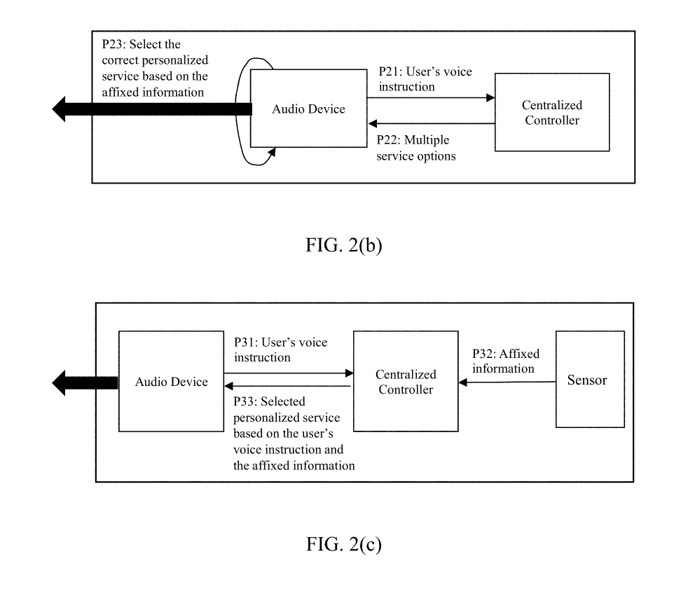

In the following, examples will be provided to illustrate how the centralized controller provides a personalized service based on the received voice instruction of the user and the affixed information related to the user. FIGS. 2(a)-2(c) illustrate schematic diagrams of operation examples to provide a personalized service based on the received voice instruction of the user and the affixed user information consistent with some embodiments of the present disclosure.

In some embodiments, the audio devices may include processors such that the audio devices may be used to obtain the affixed information related to the user. After obtaining the affixed information related to the user using the audio devices, the centralized controller may provide a personalized service using one of the following two methods.

According to a first method, the received voice instruction of the user and the obtained affixed information related to the user may be sent to the centralized controller, and the centralized controller may then generate the personalized service based on the received voice instruction of the user and the obtained affixed information related to the user. For example, the audio devices may demonstrate speech recognition capability. Through the speech recognition function, the audio devices may be able to perform a user identification process to identify the speaker/user, and further obtain the affixed information of the speaker/user, such as the user's category, etc. For example, a plurality of audio devices may be arranged in different rooms, and accordingly, the user's location may be determined by identifying which room the audio devices, receiving the voice instruction of the user, are located in. In one embodiment, the audio device may include one or more processors to identify which room the voice instruction of the user is received. In some cases, the centralized controller may not include the one or more processors in the plurality of audio devices. Therefore, the processors in the plurality of audio devices may operate independently with respect to the centralized controller to obtain the user's location.

The example described above is merely illustrative of how an audio device may obtain affixed information and should not be construed as limiting the scope of the present disclosure. Any appropriate audio device that has the capability to collect the affixed information of the speaker/user may be considered as an audio device consistent with the present disclosure.

FIG. 2(a) illustrates a schematic diagram of one method for speech recognition. Referring to FIG. 2(a), an audio device may execute operation P11 first, and then send the obtained affixed information together with the text content of the voice instruction of the user to the centralized controller. Further, during the execution of operation P12, the centralized controller may generate a personalized service based on the received affixed information and the voice instruction of the user. For example, generating the personalized service according to the voice instruction of the user may include two steps. First, a plurality of pre-determined service options according to different voice instructions may be stored. The plurality of pre-determined service options may have different permission levels and may be obtained in advance through a question-answer process (i.e., a survey) completed by the user. Further, a personalized service corresponding to the obtained affixed information may be selected from the plurality of service options. Optionally, generating the personalized service according to the voice instruction of the user may also include storing or searching feedback results corresponding to the voice instruction of the user, and then modifying or processing the feedback results based on the analysis of the obtained affixed information to generate a suitable personalized service. Finally, during the execution of operation P13, the generated personalized service may be sent to the audio device for output.

According to a second method, the audio device may only send the received voice instruction of the user to the centralized controller, and the centralized controller may provide the audio device multiple service options based on the voice instruction of the user. Further, the audio device may select the personalized service from the multiple service options based on the affixed information related to the user. FIG. 2(b) illustrates a schematic diagram of another method for speech recognition. Referring to FIG. 2(b), although an audio device may be able to obtain the affixed information related to the user, the audio device may only provide the centralized controller the text content of the voice instruction of the user during the execution of operation P21. Moreover, during the execution of operation P22, the centralized controller may provide the audio device a plurality of service options based on the voice instruction of the user. The plurality of service options may have different permission levels. Finally, during the execution of operation P23, the audio device may selectively output a suitable personalized service based on the obtained affixed information.

In another example, an audio device may send a received voice instruction of a user to the centralized controller, and the centralized controller may then extract the text content of the voice instruction of the user and also obtain the affixed information related to the user. The centralized controller may further determine and provide a service at a certain permission level based on the voice instruction of the user and the obtained affixed information. In one embodiment, the centralized controller may be physically enclosed in a device connected to the audio device, and accordingly, the audio device may send the received voice instruction of the user to the centralized controller through a wired or wireless connection. In other embodiments, the centralized controller may be distributed over various devices including the audio device. For example, a CPU of the centralized controller may include multiple portions distributed over various devices that are connected into a network. Therefore, the audio device may send the received voice instruction of the user to the portion of the centralized controller integrated into the audio device for further processing.

The above examples illustrate providing personalized services using audio devices that can directly or indirectly obtain affixed user information. FIG. 2(c) illustrates a schematic diagram of another method for speech recognition in which the audio devices are not used to obtain the affixed information rated to the user.

Referring to FIG. 2(c), during the execution of operation P31, an audio device may obtain a voice instruction of a user and then send the received voice instruction of the user to a centralized controller. However, as indicated by operation P32, the centralized controller may obtain the affixed information related to the user through one or more user identification sensors (e.g. camera, etc.). Further, during the execution of operation P33, the centralized controller may generate a personalized service based on the voice instruction received by the audio device and the affixed user information obtained by the one or more sensors, and then send the personalized service to the audio devices for output. Therefore, the process to generate the personalized service is similar to the process to generate the personalized service illustrated in FIG. 2(a). That is, the centralized controller may determine the personal service based on the received voice instruction of the user and the affixed information related to the user.

According to the present disclosure, the disclosed speech recognition devices may receive a voice instruction from a user and also obtain the affixed information related to the user. Further, based on the received voice instruction of the user and the obtained affixed information related to the user, the disclosed speech recognition devices may provide a corresponding personalized service.

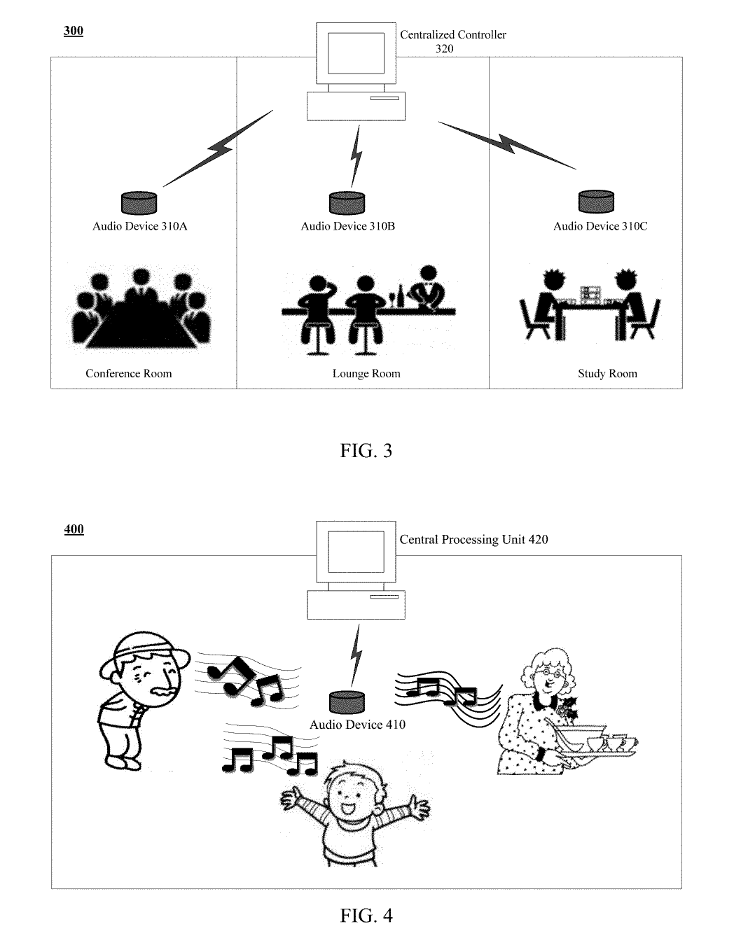

The disclosed speech recognition devices may be applied to various scenarios. FIG. 3 illustrates a schematic diagram of an application scenario of a speech recognition device consistent with some embodiments of the present disclosure.

Referring to FIG. 3, a speech recognition device 300 may include one or more audio devices. For illustration purpose, the speech recognition device 300 is described to include three audio devices: 310A, 310B, and 310C. The three audio devices may be arranged in different rooms or in separated spaces. For example, the audio device 310A may be arranged in a conference room, the audio device 310B may be arranged in a lounge room, and the audio device 310C may be arranged in a study room. In one embodiment, different rooms may correspond to different service.

In one embodiment, a user is communicating with the speech recognition device, the speech recognition device may collect the voice instruction of the user through one of the audio devices and also determine the room that the user is located in. For example, by determining the room including the audio devices that collect the voice instruction of the user, the location of the user may be determined. In other embodiments, the location of the user may be determined through other sensors such as camera, etc.

Further, the user may issue a voice instruction such as “please show the financial statements” in the conference room, the speech recognition device may collect the speech of the user through the audio device 310A. Moreover, the affixed information related to the user may be obtained through the audio devices and/or other sensors of the speech recognition device. For example, the affixed information may be the location of the user. Accordingly, the affixed information may indicate the presence of the user in the conference room. Moreover, the audio devices 310A, 310B, and 310C may have different service permission levels because the audio devices are located in different rooms. Therefore, in response to the voice instruction of the user received by the audio device 310A, a service at a corresponding service permission level may be provided.

In one embodiment, the service corresponding to the conference room may include displaying the financial statements, and accordingly, the centralized controller 320 may control other devices such as monitor, projector, etc. to display the financial statements.

In another embodiment, the service corresponding to the conference room may not include displaying the financial statements. That is, displaying the financial statements in the conference room may not be allowed. Therefore, the centralized controller 320 may provide a feedback voice message such as “the room does not have the permission to preview the financial statements” to the audio device 310A and then the feedback voice message may be broadcasted to the user. As such, the centralized controller may determine the service permission level in response to a voice instruction of a user.

Optionally, in another embodiment, the service corresponding to the conference room may not include displaying the financial statements, but the centralized controller 320 may still be able to find the financial statements and then provide the financial statements to the audio device 310A. In the meantime, the audio device 310A may be able to determine its own room. Because the determined room, having the audio device 310A, does not have the permission for displaying the financial statements, the financial statements may not be sent out. That is, the audio device 310A may determine the service permission level in response to a voice instruction of a user. In addition, in some embodiments, a feedback voice message such as “the room does not have the permission to preview the financial statements” may be sent out.

Similarly, the service permission level of the lounge room may allow providing weather information, providing film and television information, playing music songs, etc. and the service permission level of the study room may allow providing network learning materials, accessing books, etc. Therefore, according to the above service permission level of the lounge room, a user request for reviewing the financial statements in the lounge room may be denied. Similarly, a user request for playing music songs or reviewing financial statements in the study room may also be denied.

Therefore, the disclosed speech recognition devices may provide services at different permission levels for different locations.

FIG. 4 illustrates a schematic diagram of another application scenario of a speech recognition device consistent with some embodiments of the present disclosure. Referring to FIG. 4, a speech recognition device 400 may be able to provide a personalized service based on the identity of the user. For example, a lady at an age of about 30 may send out a voice instruction such as “please play music”. In response to the voice instruction, the speech recognition device 400 may collect the voice and the content of the instruction using an audio device 410 and then obtain the affixed information related to the user by analyzing the voiceprint of the user or by using other sensors such as camera, etc. In one embodiment, the affixed information may be a user's category. Therefore, the speech recognition device 400 may determine that the user is a lady at an age of about 30, and accordingly, the affixed information of the user may be determined as that the user is a lady at an age of about 30.

Further, the CPU 420 may search for songs that a lady at an age of about 30 may be interested in from an internal cloud storage device or from an external cloud storage device connected to the speech recognition device 400. Then, the CPU 420 may send the search result to the audio device 410 for broadcasting. The search result may be a playlist including one (e.g., Song 1) or more songs that a lady at an age of about 30 may be interested in. In other embodiments, the CPU 420 may send all the songs stored in the internal cloud storage device and/or in the external cloud storage device connected to the speech recognition device to the audio device 410. Based on the obtained affixed information, the audio device 410 may select and broadcast songs that are suitable for a lady at an age of about 30 from all the songs received by the audio device 410.

In another embodiment, the voice instruction “please play music” may be issued by a senior person, and accordingly, the speech recognition device 400 may play one (e.g. Song 2) or more songs that are suitable for a senior person through the audio device 410. Moreover, in some other embodiments, the voice instruction “please play music” may be issued by a child, and accordingly, the speech recognition device 400 may play one (e.g. Song 3) or more songs that are suitable for a child through the audio device 410. Therefore, although different users may issue a same voice instruction (that is, the user's requests are expressed in a same way and/or contain a same content), the disclosed speech recognition device may provide different services based on different categories of the speakers (i.e., different user's categories).

Further, the disclosed speech recognition device may also be able to define different service permission levels corresponding to different categories of the users. For example, in response to a request for watching a restricted film (i.e., a gunfight film) from a child, the disclosed speech recognition device may deny the request and may also send a feedback message to the audio devices for broadcast. Similarly, the disclosed speech recognition devices may be able to define different service permission levels based on different environmental parameters. For example, a camera connected to a speech recognition device may detect the presence of child when a request for watching a restricted film is received. Even the voice instruction is from an adult, the speech recognition device may still deny the request and may send a feedback message to explain the reason of the denial.

Moreover, in one embodiment, although a same service needs to be provided in response to the voice instructions of different users, the service may still be provided using different presenting methods corresponding to the different categories of the users. For example, during a broadcast of the weather condition, the audio device may use a respectful tone and/or a slow speed to broadcast the weather condition to a senior user, use a normal tone and/or a normal speed to broadcast the weather condition to a junior user, and use a tone of elders and/or a slow speed to broadcast the weather condition to a child user. Therefore, according to the example described above, the users are divided into at least three categories: senior users, junior users, and child users. The definition of the categories of the users in the above example is merely used to illustrate a method for defining the categories of the users. In other embodiments, the users may be divided into one or more categories, and the criteria for defining the categories of the users may not be limited to the age of the user. According to the examples described above, the presenting method of the service may include the tone of broadcast and the speed of broadcast. In other embodiments, the presenting method may also include the speaker volume. Moreover, in some other embodiments, the provided personalized service may include displaying a text content, and accordingly, the presenting method may include the displaying color, the displaying font, the font size, etc.

The above illustration provides various examples of the application scenarios of the disclosed speech recognition devices. As described above, the speech recognition devices may collect a voice instruction of a user and also obtain affixed information related to the user, and then the speech recognition devices may provide a personalized service based on the received voice instruction of the user and the obtained affixed information related to the user.

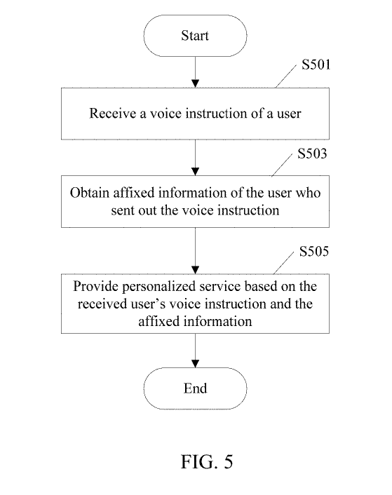

The present disclosure also provides a voice recognition method. FIG. 5 shows a schematic flowchart of a speech recognition method consistent with some embodiments of the present disclosure. Referring to FIG. 5, the voice recognition method may include the following steps.

In Step S501, a voice instruction of a user may be received.

In Step S503, in response to the received voice instruction of the user, affixed information related to the user (i.e. the speaker) may be obtained. The affixed information related to the user may be obtained by analyzing the received voice instruction of the user. Alternatively, the affixed information related to the user may be collected by one or more sensors.

In Step S505, a personalized service may be provided based on the received voice instruction of the user and the obtained affixed information. Moreover, providing a personalized service may include providing a service at a certain permission level and/or using a certain presenting method. That is, providing different personalized services may be referred to as providing services at different permission levels and/or providing a same service using different presenting methods. In one embodiment, the affixed information may include at least one of the user's location, the user's category, etc.

According to the disclosed voice recognition methods, by collecting voice instruction of user and obtaining affixed information related to the user, a personalized service may be provided, and a more intelligent speech recognition device may be thus achieved.

As described above, the present disclosure provides speech recognition devices and speech recognition methods. The disclosed speech recognition devices and speech recognition methods may be able to provide a personalized service based on the voice instruction of the user and the affixed information related to the user.

Further, the methods, devices, and units and/or modules according to various embodiments described above may be implemented by executing computing-instructions-containing software using computational electronic devices. The computational electronic devices may include general-purpose processor, digital-signal processor, application specific processor, reconfigurable processor, and other appropriate devices that are able to execute computing instructions. The devices and/or components described above may be integrated into a single electronic device, or may be distributed into different electronic devices. The software may be stored in one or more computer-readable storage media.

The computer-readable storage media may be any medium that is capable of containing, storing, transferring, propagating, or transmitting instructions of any kind. For example, the computer-readable storage media may include electrical, magnetic, optical, electromagnetic, infrared, or semiconductor systems, devices, instruments, or propagation media. For example, magnetic storage devices such as magnet-coated tape and hard drive disc (HDD), optical storage devices such as compact disc read-only memory (CD-ROM), memories such as random access memory (RAM) and flash memory, and wired/wireless communication links are all examples of readable storage media. The computer-readable storage media may include one or more computer programs including computing codes or computer-executable instructions. Moreover, when the computer programs are executed by processors, the processors may follow the method flow described above or any variations thereof.

The computer programs may include computing codes containing various computational modules. For example, in one embodiment, the computing codes of the computer programs may include one or more computational modules. The division and the number of the computational modules may not be strictly defined. In practice, program modules or combinations of program modules may be properly defined such that when the program modules or combinations are executed by processors, the processors may operate following the method flow described above or any variations thereof.

Further, in the present disclosure, relational terms such as first, second, and the like, may be used solely to distinguish one entity or action from another entity or action without necessarily requiring or implying any actual such relationship or order between such entities or actions. The terms “comprises,” “comprising,” or any other variation thereof, and the terms “includes,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” or “includes . . . a” does not, without more constraints, preclude the existence of additional identical elements in the process, method, article, or apparatus that comprises the element.

Various embodiments of the present specification are described in a progressive manner, in which each embodiment focusing on aspects different from other embodiments, and the same and similar parts of each embodiment may be referred to each other. Because the disclosed devices correspond to the disclosed methods, the description of the disclosed devices and the description of the disclosed methods may be read in combination or in separation.

The description of the disclosed embodiments is provided to illustrate the present disclosure to those skilled in the art. Various modifications to these embodiments will be readily apparent to those skilled in the art, and the generic principles determined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A speech recognition method, comprising:
receiving a voice instruction of a user;
in response to the received voice instruction of the user, obtaining affixed information related to the user; and
providing a personalized service based on the received voice instruction of the user and the affixed information.

2. The speech recognition method according to claim 1, wherein:
the affixed information related to the user includes at least one of a user's location, a user's age, a user's gender, and a user's identity.

3. The speech recognition method according to claim 2, further including:
obtaining the user's age, the user's gender, and the user's identity by analyzing a voiceprint of the user.

4. The speech recognition method according to claim 2, wherein:
determining the user's location by at least one audio device.

5. The speech recognition method according to claim 1, wherein obtaining the affixed information related to the user includes:
obtaining the affixed information by analyzing the received voice instruction of the user.

6. The speech recognition method according to claim 5, wherein analyzing the received voice instruction of the user includes:
pre-storing voiceprints of different users; and
comparing the received voice instruction of the user to the pre-stored voiceprints of different users to obtain the affixed information of the user.

7. The speech recognition method according to claim 5, wherein:
the affixed information of the user obtained by comparing the received voice instruction of the user with the pre-stored voiceprints of different users includes a user's category.

8. The speech recognition method according to claim 5, wherein:
the user's category is defined based on at least one of the user's age, the user's gender, and the user's identity.

9. The speech recognition method according to claim 1, wherein obtaining the affixed information related to the user includes:
collecting the affixed information through at least one user identification sensor.

10. The speech recognition method according to claim 1, wherein providing the personalized service based on the received voice instruction of the user and the affixed information includes:
pre-storing a plurality of service options at different permission levels corresponding to different voice instructions and different affixed information related to different users;
selecting a personalized service corresponding to a permission level from the pre-stored service options at different permission levels based on the received voice instruction of the user and the affixed information related to the user; and
providing the personalized service at the permission level.

11. The speech recognition method according to claim 1, wherein providing the personalized service based on the received voice instruction of the user and the affixed information includes:
pre-storing a plurality of service options corresponding to different voice instructions and different presenting methods corresponding to different affixed information related to different users; and
selecting a personalized service from the plurality of service options and a presenting method from the different presenting methods, based on the received voice instruction of the user and the affixed information, wherein the presenting method includes at least one of broadcasting speed, speaker volume, displaying color, displaying font, and font size; and
providing the personalized service using the presenting method.

12. The speech recognition method according to claim 1, wherein providing the personalized service based on the received voice instruction of the user and the affixed information includes:
receiving the voice instruction of the user by at least one audio device;
obtaining the affixed information related to the user by the at least one audio device;
sending the voice instruction of the user and the affixed information related to the user to a centralized controller; and
selecting and providing the personalized service based on the voice instruction of the user and the affixed information by the centralized controller.

13. The speech recognition method according to claim 1, wherein providing the personalized service based on the received voice instruction of the user and the affixed information includes:
receiving the voice instruction of the user by at least one audio device;
obtaining the affixed information related to the user by the at least one audio device;
sending the voice instruction of the user to a centralized controller from the at least one audio device;
sending multiple service options to the at least one audio device from the centralized controller; and
selecting and providing the personalized service based on the voice instruction of the user and the affixed information by the at least one audio device.

14. The speech recognition method according to claim 1, wherein:
receiving the voice instruction of the user by at least one audio device;
obtaining the affixed information related to the user by at least one user identification sensor;
sending the voice instruction of the user to a centralized controller from the at least one audio device and sending the affixed information related to the user to the centralized controller from the at least one user identification sensor; and
selecting and providing the personalized service based on the voice instruction of the user and the affixed information by the centralized controller.

15. A speech recognition device, comprising:
a centralized controller, coupled with a storage device for pre-storing a plurality of service options corresponding to voice instructions and affixed information of users, wherein:
in response to a voice instruction provided from at least one audio device, the centralized controller provides one of a service and service options based on the voice instruction and the affixed information of a user to the at least one audio device to provide a personalized service.

16. The device according to claim 15, wherein, in response to the voice instruction:
one of the centralized controller and the at least one audio device determines the affixed information of the user based on the voice instruction; and
the centralized controller selects the service from the plurality of pre-stored service options based on the voice instruction and the affixed information of the user as the personalized service, and sends the personalized service to the at least one audio device for the at least one audio device to provide the personalized service.

17. The device according to claim 15, wherein, in response to the voice instruction:
the at least one audio device determines the affixed information of the user based on the voice instruction;
the centralized controller selects multiple service options from the plurality of pre-stored service options based on the voice instruction of the user, and sends the multiple service options to the at least one audio device for the at least one audio device to select therefrom and to provide the personalized service from the multiple service options based on the affixed information of the user.

18. A speech recognition device, comprising:
at least one audio device, each comprising a sound collector for receiving a voice instruction of a user and a processor,
wherein:
in response to a voice instruction of a user received through the sound collector, the processor determines affixed information of the user, receives, from a centralized controller, one or more of a service and service options based on the voice instruction and the affixed information of the user, and provides a personalized service.

19. The device according to claim 18, wherein:
in response to the voice instruction of the user, the centralized controller sends multiple service options to the processor of one of the at least one audio device, and
the processor selects the personalized service from the multiple service options based on the affixed information of the user, and provides the personalized service.

20. The device according to claim 18, wherein each of the at least one audio device further includes:
a storage for pre-storing voiceprints of different users, wherein:
the affixed information of the user is obtained by comparing the voice instruction of the user with the pre-stored voiceprints of different users.
